(19) United States
(12) Patent Application Publication
(10) Pub. No.: US 2009/0185679 A1
(43) Pub. Date: Jul. 23, 2009

(54) Method for electronically signing electronic documents and method for verifying an electronic signature

(75) Inventors: Sultan Haider, Erlangen (DE); Georg Heidenreich, Erlangen (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT

(21) Appl. No.: 12/320,200

(22) Filed: Jan. 21, 2009

(30) Foreign Application Priority Data
Jan. 23, 2008 (EP) EP 08001230

(51) Int. Cl. H04L 9/30

(52) U.S. Cl. 380/30

(57) ABSTRACT

A medical professional registers himself with the trust centre (TC) or trusted registry (TR) acting on behalf of and/or operated by the mobile communication service provider. According to an embodiment of the present invention, the trust centre or trusted registry generates a pair of keys (“private key, public key”) and associates the private key with the mobile-phone identity (IMEI, SIM-chip-number or phone number) in a secret table stored at the TC or TR. The TC or TR also associates the public key with the medical author's name (plus office address) as an entry into a directory.

### PRIORITY STATEMENT

The present application hereby claims priority under 35 U.S.C. §119 on European patent application number EP 08001230 filed Jan. 23, 2008, the entire contents of which is hereby incorporated herein by reference.

### FIELD

Embodiments of the invention are generally related to supporting easy signature by authors, e.g. medical professionals, who want to authenticate authorship of or validate electronic documents and for verification of such signatures by readers who want to validate content of such electronic documents.

### BACKGROUND

In a classical “offline” scenario according to the prior art based on conventional paper, authors ink-sign documents after validating them. Such documents may then be stored locally or sent to parties trusting that signature. Trust of ink-signatures decreases in a larger community, because some ink-signature typically is not well-known in a large community. Currently, according to another prior art, secure “smartcards” with keys and algorithms on-card are being designed to allow for electronically signing documents on the client-side. Specialized trusted hardware at the client side is needed to maintain end-to-end-security in the smartcard scenario.

### SUMMARY

In at least one embodiment, the present invention aims at an improvement of this situation.

According to at least one embodiment of the present invention, established device(s)/method(s) of communication (e.g. mobile phones) used for secure communication replace dedicated client-side IT-systems for the authentication of validated documents. It is assumed that e.g. a medical professional—acting as an author of medical documents—operates a mobile phone which is serviced by some mobile phone service provider, such that the medical professional is a registered client of the mobile phone service provider. Instead of mobile phones, similar mobile communication devices can be used by our scheme. A standardized resource locator, i.e. e.g. a storage address or a so called “uniform resource locator” (URL), used e.g. in the http-protocol, may be used to identify and locate a document.

In cases where these electronic documents are stored decentrally, an example embodiment of the invention suggests to store document references and signatures together in a central registry.

At least one embodiment of the proposed invention suggests to use a communication device - preferably a mobile communication device—for signing electronic documents and makes use of the trust that is already established between the corresponding communication service provider and the e.g. medical authors being clients of such a provider.

According to an example embodiment of the invention, a trusted central or centralized registry is used to verify the signatures instead of the reader, who is just given a “confirm/deny” information on his verification requests.

### BRIEF DESCRIPTION OF THE DRAWINGS

In the following, the invention is described in more detail by help of some figures and example embodiments.

FIG. 1 shows in a schematic manner a process of selecting and/or signing a document according to an example embodiment of the invention.

FIG. 2 shows in a schematic manner a process of verifying a signature according to an example embodiment of the invention.

FIG. 3 shows in a schematic manner a process of generating table entries with signature keys according to an example embodiment of the invention.

FIG. 4 shows in a schematic manner a registration and key generating process according to an alternative embodiment of the invention.

FIG. 5 shows in a schematic manner a process of uploading a document to a document storage according to an example embodiment of the invention.

FIG. 6 shows in a schematic manner a process of viewing an unvalidated document according to an example embodiment of the invention.

FIG. 7 shows in a schematic manner a process of key generation and local key storage on a client's device according to an alternative embodiment of the invention.

FIG. 8 shows in a schematic manner a process of signing a centrally stored document according to an example embodiment of the invention.

FIG. 9 shows in a schematic manner a process of signing with a private key stored on a client's device according to an alternative embodiment of the invention.

FIG. 10 shows in a schematic manner a process of verifying a signature according to an example embodiment of the invention.

FIG. 11 shows in a schematic manner a process of generating signature keys according to an example embodiment of the invention.

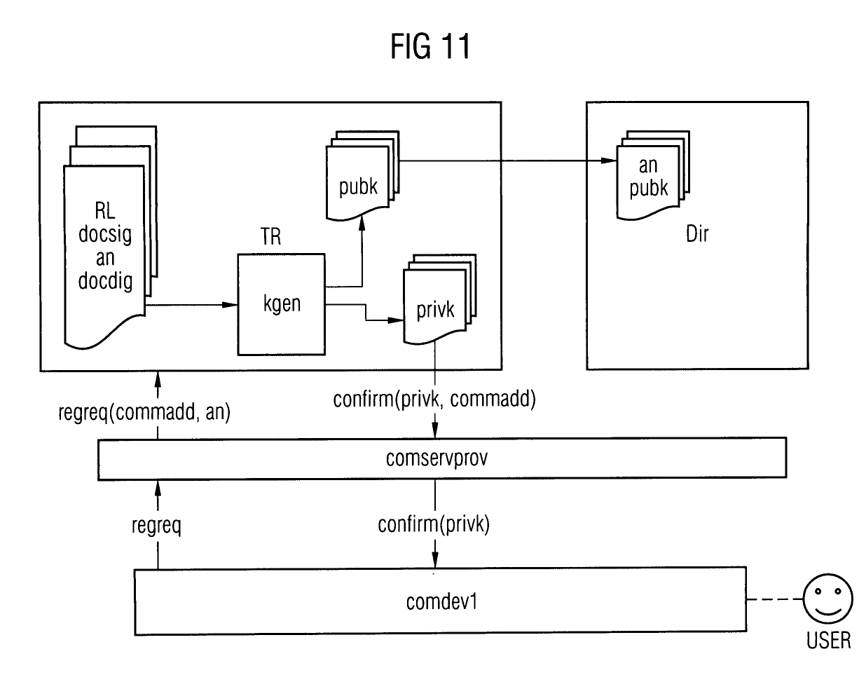

FIG. 12 shows in a schematic manner a process of registering and signing in a single procedure according to an example embodiment of the invention.

FIG. 13 shows in a schematic manner a process of verifying a document at a trusted registry according to an example embodiment of the invention.

FIG. 14 shows in a schematic manner a process of obtaining a verification for a given document info by a client according to an example embodiment of the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the present invention uses, for example, established encryption schemes, either symmetric or asymmetric. A typical scenario could be like this:

A medical professional registers himself with the trust center (TC) or trusted registry (TR) acting on behalf of and/or operated by the mobile communication service provider. According to an embodiment of the present invention, the trust center (TC) or trusted registry (TR) generates a pair of keys (“private key, public key”) and associates the private key with the mobile-phone identity (IMEI, SIM-chip-number or phone number) in a secret table stored at the TC or TR. The TC or TR also associates the public key with the medical author's name (plus office address) as an entry into a directory.

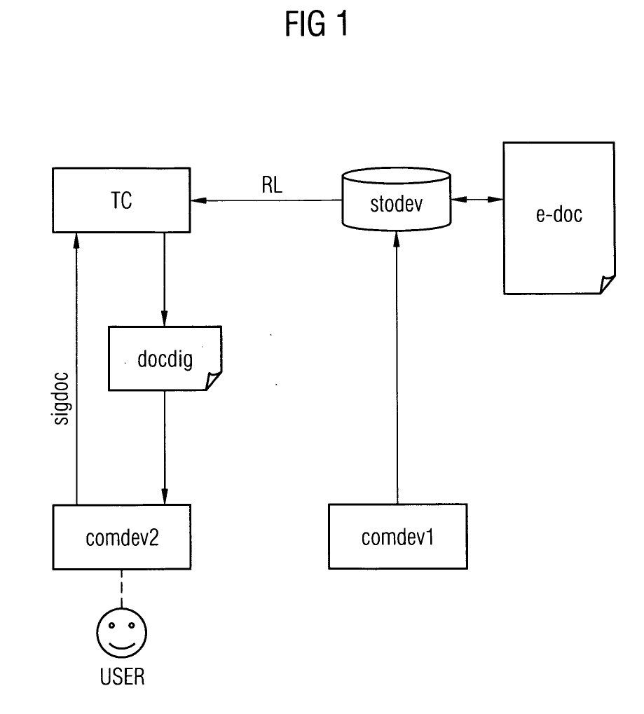

As shown in FIG. 1, a document (e-doc), which may have been selected e.g. by the user of a communication device comdev1, can be signed by the user (USER) of a communication device comdev2, by transmitting a signature (sigdoc) to a trust center (TC), the signature being an encrypted digest (docdig) of this document (e-doc). The digest has been sent to the communication device (comdev2) by the trust center (TC) after the resource locator (RL) of the document has been transferred from the storage device (stodev) to the trust center (TC). The resource locator may e.g. be a so called Uniform Resource Locator (URL) known in the internet (http), but may also be some other kind of unique identifier of the document. The document (e-doc) may be stored on a storage device (stodev), which can be part of the trust center (TC) or can also be a remote storage device, accessible through a (e.g. computer) network, e.g. like the internet.

According to one example embodiment of the present invention, an example embodiment of the invention may be implemented in a method for electronically signing electronic documents comprising the following steps:
A) a first communication device (comdev1) is used to
A1) select an existing document (e-doc) to be signed, the document being stored on a storage device (stodev) or to
A2) upload a document (e-doc) to be signed to a storage device (stodev) and to
A3) submit or cause the storage device or a processor unit associated with that storage device to submit a resource locator (RL) uniquely identifying this document (e-doc) to a trust center (TC), where the user (USER) of a second communication device (comdev2) is registered;
B) this second communication device (comdev2)—which may be identical to the first communication device (comdev1)—is then used to
B1) authenticate the user (USER) as authorized to electronically sign at least some electronic documents and to
B2) cause the trust center (TC) to sign the selected or uploaded document with the electronic signature of this user;
C) a signature (sigdoc) of this document (e-doc) is then created by the trust center (TC) by help of a key associated with this user;
D) by the trust center, the signature (sigdoc) is then associated with the document (e-doc) to be signed as the user's signature of this document.

According to another example embodiment of the present invention, an example embodiment of the invention may be implemented in a method for electronically signing electronic documents comprising the following steps:
A) a first communication device (comdev1) is used to

A1) select an existing document (e-doc) to be signed, the document being stored on a storage device (stodev) or to

A2) upload a document (e-doc) to be signed to a storage device (stodev) and to

A3) submit or cause the storage device or a processor unit associated with that storage device to submit a resource locator (RL) uniquely identifying this document (e-doc) to a trust center (TC), where the user (USER) of a second communication device (comdev2) is registered;
B) this second communication device (comdev2)—which may be identical to the first communication device (comdev1)—is then used to

B1) authenticate the user (USER) as authorized to electronically sign at least some electronic documents and to

B2) cause the trust center (TC) to create a digest (docdig) of the document (e-doc) to be signed and to

B3) send the generated digest to the second communication device (comdev2);
C) a signature (sigdoc) of this digest (docdig) is then created by the second communication device (comdev2) by help of a key associated with this user, stored locally on this second communication device (comdev2);
D) the signature (sigdoc) is then sent back to the trust center (TC) and there associated with the document (e-doc) to be signed as the user's signature of this document.

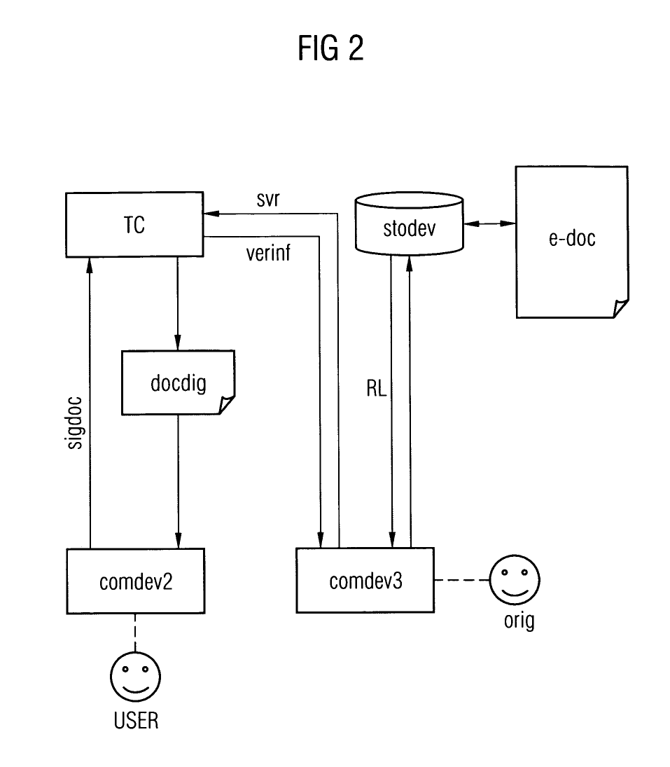

As shown in FIG. 2, verifying an electronic signature associated with a document (e-doc) stored on a storage device (stodev) may be done according to an embodiment of the present invention by a method comprising the following steps:
A) a third communication device (comdev3)—which may be identical to the first communication device (comdev1) and/or the second communication device (comdev2)—is used to

A1) select an existing document (e-doc), the signature of which is to be verified, and to

A2) submit a signature verification request command (svrc) to a trust center (TC) where the owner of the signature to be verified is registered;
B) the signature is then decrypted by the trust center and
C) information (verinf) is submitted to the originator (orig) of the request (svrc) allowing the originator to verify the signature.

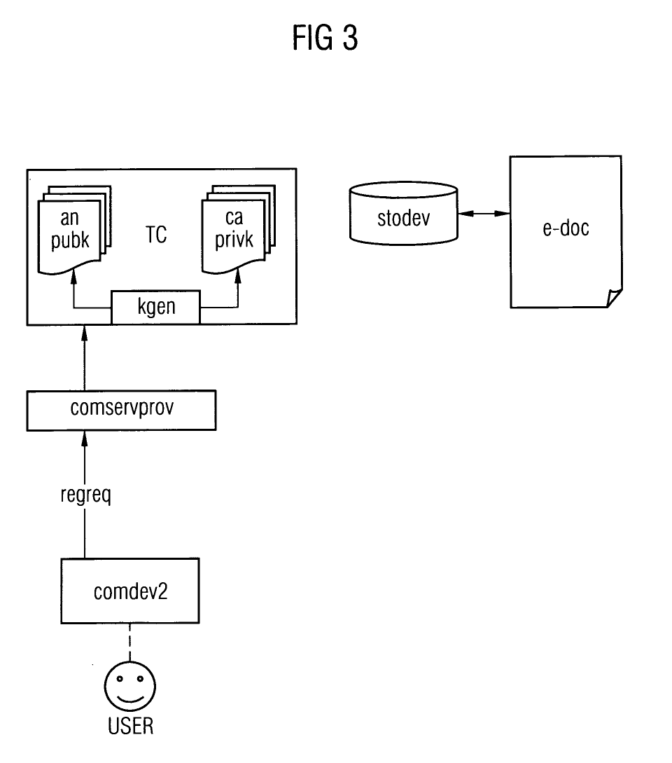

The process of generating table entries with signature keys is shown in FIGS. 3 and/or 11. According to an example embodiment of the present invention, the user (USER) of a communication device (comdev2) submits a registration request (regreq) to his communication service provider (comservprov), who forwards this request—after including the author name (an) and the communication address (ca)—to the trust center (TC). In the trust center (TC), a public key (pubk) and a private key (privk) are generated by a key generation process (kgen), and the private key is associated with the communication address (ca), whereas the public key is associated with the author name (an). This can be stored on a directory (Dir).

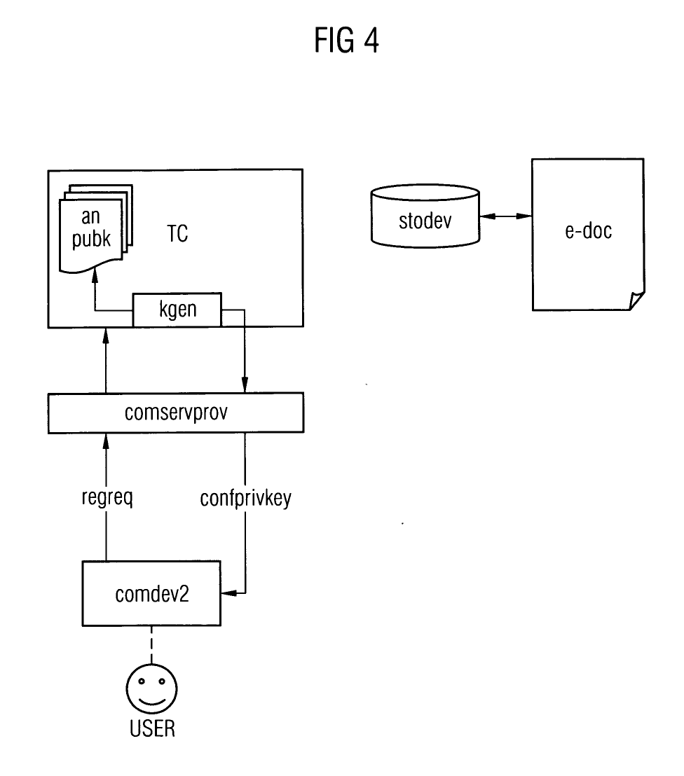

According to an alternative embodiment of the present invention the author's mobile phone is used to hold his private key: Instead of managing a secret table with private keys, the TC or TR might as well send back the generated private key to the mobile communication device of the medical author. In that case, the security requirements for the TC or TR are lowered and the list of “Keys and Authors” may be a public directory. This embodiment is illustrated in FIG. 4. After key generation, the private key (privk) is submitted from the trust center (TC) via the communication service provider (comservprov) to the communication device (comdev2) of the registered user (USER).

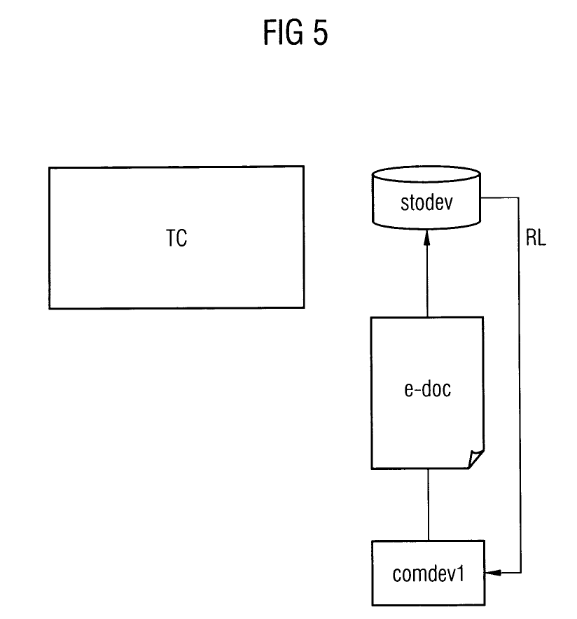

At another (e.g. later) instance in time, the registered (e.g. medical) author may want to upload a document to the storage location accessible to other (not necessarily registered) readers. For this purpose, as shown in FIG. 5, any IT-device connected to the storage Server may be used—including the author's mobile communication device, but also including devices (comdev1) automatically (or on behalf of a non-medical Person like assistants, nurses, patients or their related persons) uploading diagnostic or monitoring data without prior validation through medical staff. After the document (e-doc) has been uploaded to the storage device (stodev), a resource locator (RL), e.g. the so called URL or another suitable unique identifier will be submitted to the communication device (comdev1), so that the document may be identified at a later time.

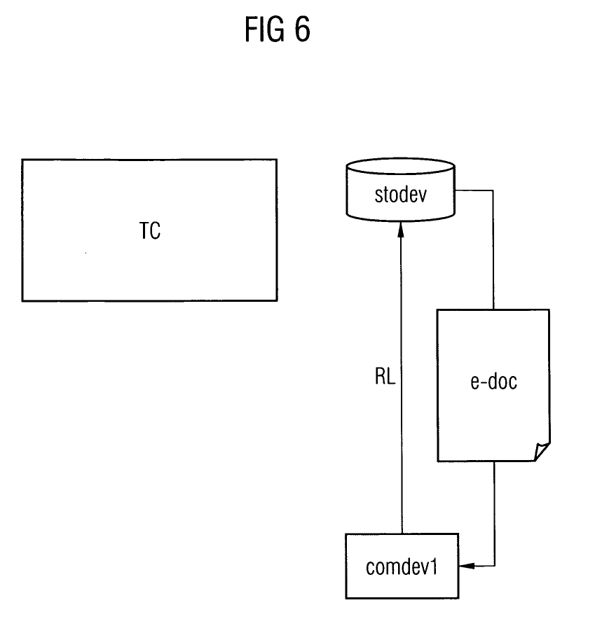

At any later instance in time, the medical author may want to view the uploaded document and eventually validate the content. This situation is illustrated in FIG. 6. To this end, he submits the resource locator (RL) to the storage device (stodev) and receives the associated document (e-doc) in return. In the case of automatic (or other unvalidated) upload, this viewing also serves the purpose of obtaining the storage address, e.g. the URL, for identifying and locating the document to be validated and signed.

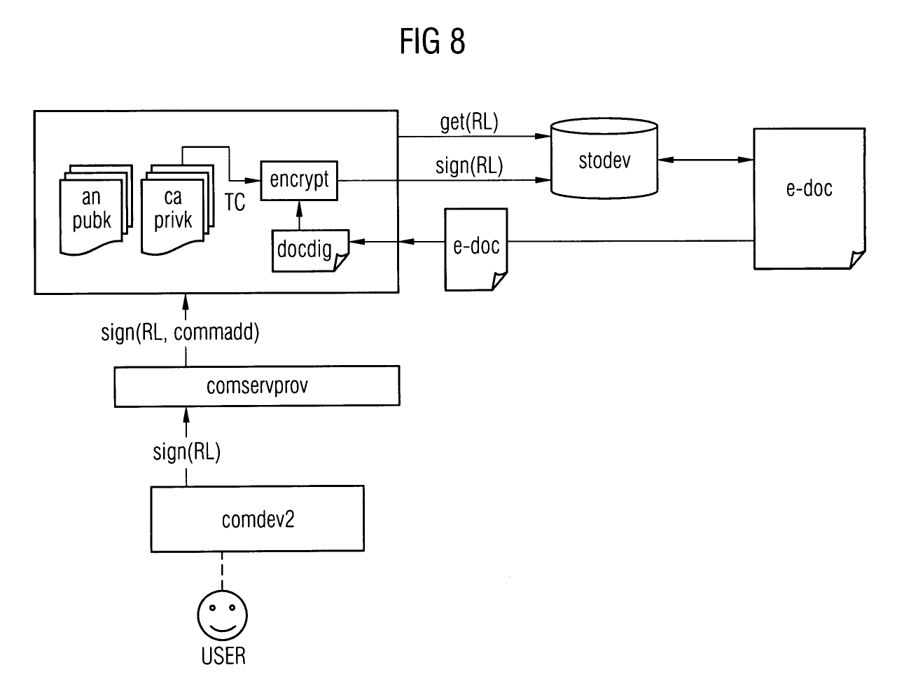

At any later instance in time, the registered medical author may want to authenticate authorship/reviewership of some centrally or decentrally stored document which he validated. He therefore—according to an example embodiment of the present invention—sends the document (i.e. uses e.g. a URL to instruct the central storage to send the document on his behalf) to the trust center (TC). There a digest—a number specifically depending on the content of the document—is generated and encrypted using the private key of the medical professional and—in encrypted form—sent back to the central storage where it will be attached to the document as a signature (together with specifications of the trust center (TC) and the algorithms used). This situation is illustrated in FIG. 8.

At any (possibly) later instance in time, the registered medical author may want to “sign a document”, i.e. state his authorship/reviewership of some identified/located document which he validated and therefore sends the document' RL (i.e. a URL) to the trusted registry (TR), which loads that document and creates a digest—a number specifically depending on the content of the document—and asks the client's mobile device to encrypt that digest using the private key of the medical professional and registers a new record (consisting of the URL, the encrypted digest as well as the plaintext (i.e. unencrypted) digest plus possibly some useful search attributes) to be inserted into the registry's reference list.

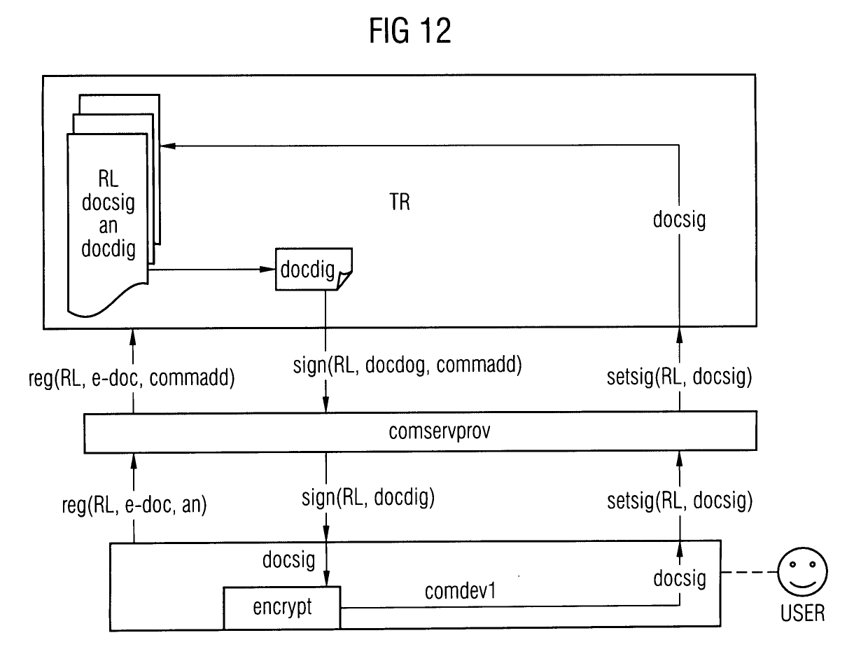

Registered (medical) authors may (FIG. 12) perform these sequences of steps as a single command using their mobile communication device, which provides the author's identity against the TR or TC and answers encryption requests.

Therefore there are at least two alternative implementations of embodiments of the present invention, one using the author's mobile phone to hold his private key. In this case, instead of encrypting the digest using the author's private keys, the TC or TR will send the generated digest to the mobile communication device of the medical author, which then responds with the encrypted form of the digest using the private key stored locally on the mobile communication device.

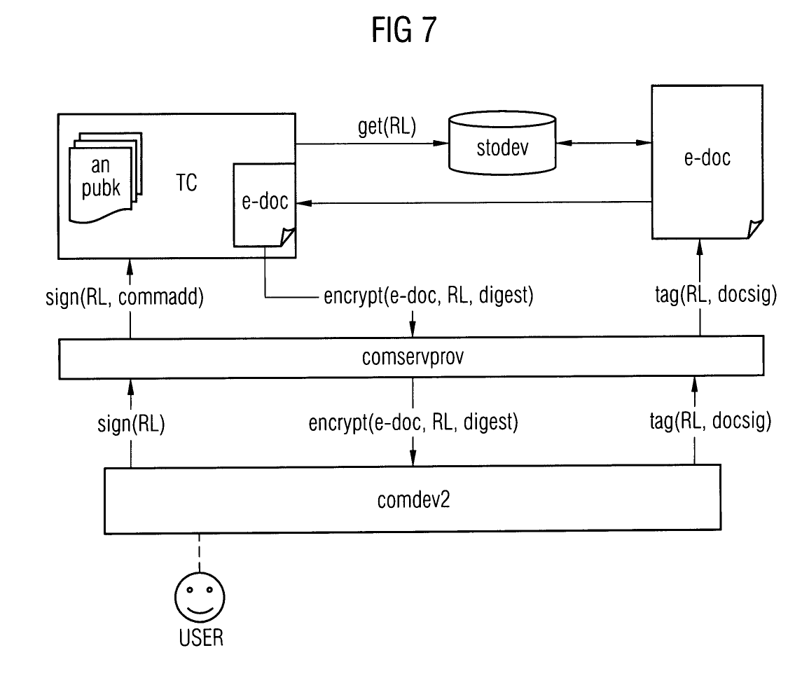

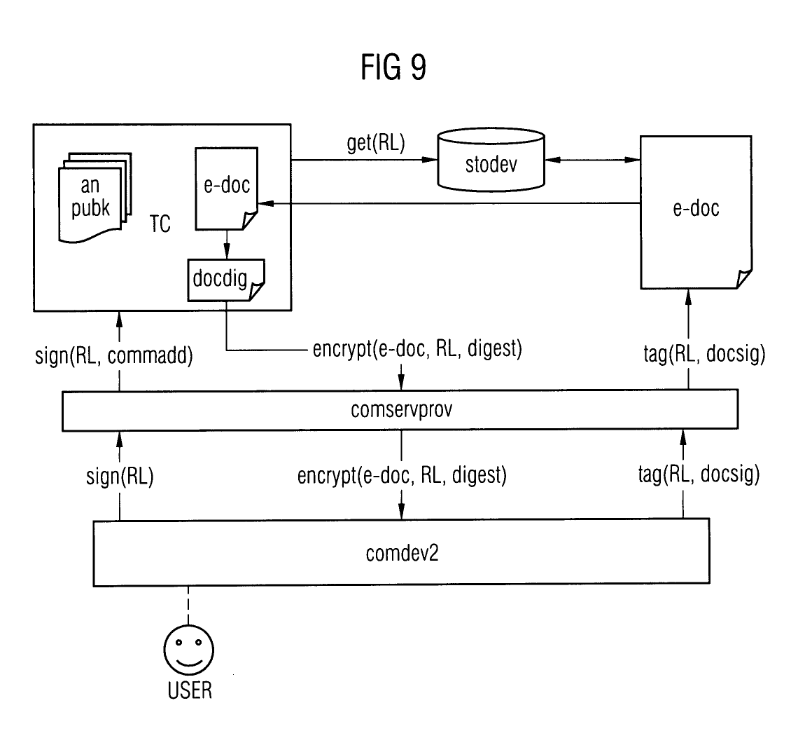

According to another alternative implementation, even the digest creation algorithm may be operated on the mobile device, e.g. in cases where the document is available locally (at the medical author's site) and its whole signature is generated (by creating a digest and encrypting that digest) by the mobile device, which then sends the signed document together with its URL (or another suitable identifier/locator or address) to the (e.g.) central storage. This situation is illustrated in FIGS. 7 and 9. The registered user (USER) uses his communication device (comdev2) to cause the trust center (TC) to get the document (e-doc) to be signed. To this end, he submits a request (sign(RL)) designating the identity (RL) of the document (e-doc) to the trust center (TC) via his communication provider (comservprov), who ads the communication address (commadd) to the request (sign(RL, commadd)). The trust center (TC) gets (get(RL)) the document (e-doc) corresponding to the resource locator (RL) from the storage device (stodev), creates a digest, and submits (encrypt(e-doc, RL, digest) the digest to the communication device (comdev2). There the digest is encrypted with the private key, whereby a signature (docsig) is created, which is then submitted as a tag (tag(RL, docsig)) to the storage device (stodev), where it is associated to the document (e-doc).

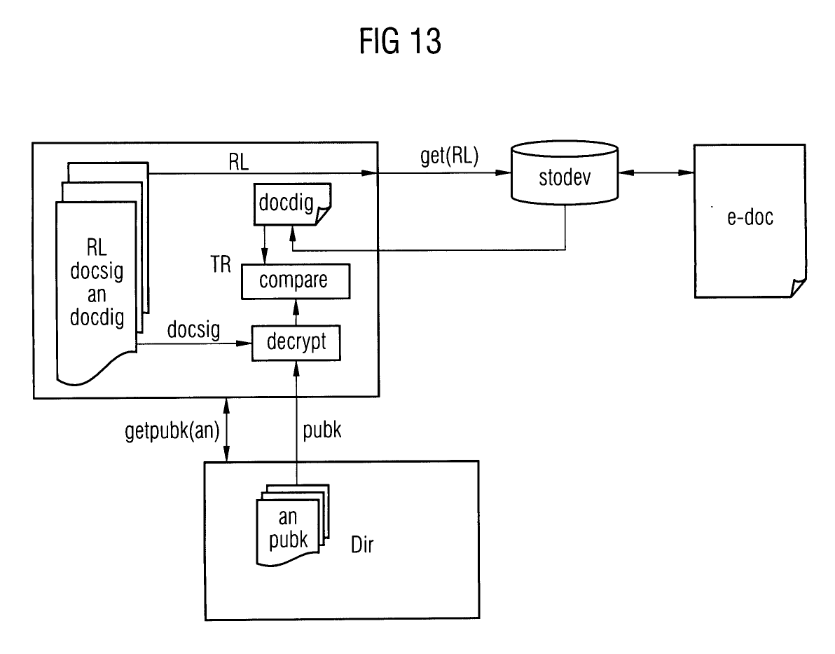

At any later instance of time and at the discretion of the trusted registry (TR), the records in the registry may be used to verify the signature against the document storage, in order to exclude a compromised communication link or a compromised decentralized storage. For that purpose, as e.g. shown in FIG. 13, the document is obtained from the storage and a new digest is generated and compared against the decrypted signature, unsigning the public key obtained from the (trusted) directory if they do not match, the entry will be deleted or marked a questionable.

At any later instance in time, some reader may want to verify authorship/reviewership of the specified, named author/reviewer of some registered or centrally stored document and therefore

sends the documents resource locator (e.g. the URL) to the trusted registry (TR) or

sends the document (i.e. uses the URL to instruct the central storage to send the document on his behalf) to the trust centre,

where a digest—specifically depending on the content of the document—is generated and compared to the

the digest (i.e. the plain text form of the signature) also attached to the document referenced by the registry or

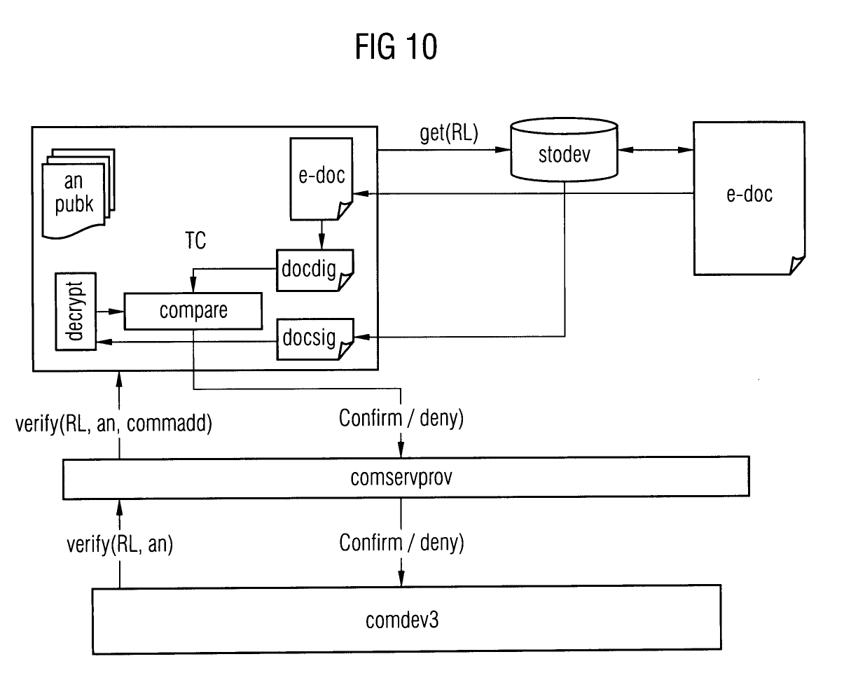

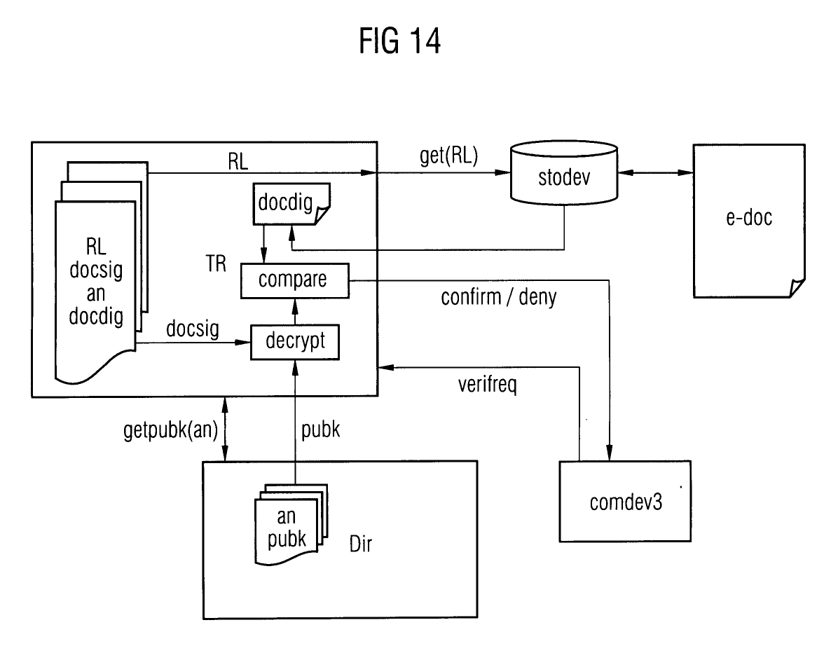

the decrypted form of the signature (using the public key of the specified medical author for decryption) attached to the document returned by the central storage. This situation is shown in FIGS. 10 or 14.

The TC or TR will report (confirm/deny), whether the signature is valid, which is true if and only if the decrypted (decrypt) signature (docsig) matches the digest (docdig). Any reader may perform this sequence of steps as a single command on any identified/located document with such a signature.

According to another embodiment of the invention, there is an alternative using symmetric keys: Since the TC never releases the public keys of registered medical authors, they may as well be identical to the private key used for encryption. Thus, symmetric encryption—with the same key used for encrypting and decrypting—may be used as well in this scheme. The only difference to the trust center (described above) will be, that a single key is generated and inserted into the only table of keys in the TC. Both generation and verification of the signature is done within the TC and with the same key. The “symmetric” scheme does, however, exclude the “private key on mobile device” variant, because the trust center has anyway the highest security requirements in this case. Brute force attacks against the keys have, however, to be avoided using dedicated measures in the TC, since attacking the “decryption key” in this scheme harms the “encryption key” at the same time.

Some embodiments of this invention are especially suitable for cases, in which the data stored (e.g. in some decentralized storage) or the data uploaded, i.e. the document, is not authored by the one who signs it, but is authored by some third party (e.g. assistant, nurse, patient, other person) or by some automatic sender that stores or uploads unvalidated (“raw”) data. In some of these cases, the invention proposes that the (medical) “authorizer” just validates the content of the data by looking at it as it is already stored on the (central or decentralized) storage server and then signs it using the methods proposed above.

At least one embodiment of the invention also covers the case, where—instead of mobile phones—other IT-devices with sender/receiver-functionality are used by the (medical) author or signer, provided these devices have a unique communication identity (such as IP internet address, SIM chip number, telephone ENUM or, IMEl or similar address) and provided this communication identity is linked to a registered entity (as owner or User: “medical author”).

It can be easily inferred from the above disclosure of embodiments of the present invention, that important advantages of at least one embodiment of the present invention or at least some respective embodiments of this invention are as follows:

a medical professional's identity is provided without extra hardware (cell phone/SIM access provider);

only few assumptions are necessary about client's information technology equipment;

simple and existing software can be used to implement the invention, hardware and protocols are combined to support e-signature;

higher availability may be achieved when compared to complex telematics IT-systems and health cards;

storage Server(s) may be separated from signature generation/verification;

content source(s) may be separated from the communication service provider;

content source(s) may be separated from signature generation/verification;

a central registry may be used for managing decentralized storage of documents;

only secure places for the generation of a digest are needed;

each private key may be restricted to be always kept with the (medical) client;

the technical signature-to-documents verification will be separated from the reader's signature request.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. Method for electronically signing a document, comprising:
using a first communication device to select a document to be signed, stored on a storage device, or to upload a document to be signed to the storage device;
using the first communication device to submit, or cause the storage device or a processor unit associated with the storage device to submit, a resource locator uniquely identifying the selected or uploaded document to a trust center, where a user of a second communication device is registered;
using the second communication device to authenticate the user as authorized to electronically sign at least some electronic documents;
using the second communication device to cause the trust center to generate a digest of the document to be signed and to send the generated digest to the second communication device;
generating a signature of the generated digest, by the second communication device, using a key associated with the user, stored locally on the second communication device; and
sending the signature back to the trust center and associating the sent signature with the document to be signed as the user's signature of the document.

2. Method according to claim 1, wherein the key is or has been generated by the trust center.

3. Method according to claim 1, wherein the key is a private key of an asymmetric crypto system comprising pairs of public and private keys.

4. Method according to claim 1, wherein the second communication device is capable of communicating with the trust center according to an authentication protocol, whereby the authentication of the second communication device and a registered user of the second communication device are checked.

5. Method according to claim 1, wherein the second communication device is a cellular mobile phone equipped with software supporting the method.

6. Method for verifying a signature associated with a document stored on a storage device, comprising:
using a communication device (comdev3)—which may be identical to the first communication device (comdev1) and/or the second communication device (comdev2)—is used to using a communication device to select the stored document, the signature associated with the selected document being the signature to be verified;
using the communication device to submit a signature verification request command to a trust center where an owner of the signature to be verified is registered;
decrypting the signature by the trust center; and
submitting information to the originator of the signature verification request, allowing the originator to verify the signature.

7. Method according to claim 6, wherein the signature verification request command is submitted to the trust center together with a resource locator uniquely identifying the selected document and wherein the trust center then locates the document and its associated signature to decrypt the signature.

8. Method according to claim 6, wherein the signature verification request command is submitted to the trust center together with a signature to be verified and wherein the signature is then decrypted by the trust center.

9. Method according to claim 6, wherein the information submitted to the originator is the decrypted signature.

10. Method according to claim 9, wherein the decrypted signature is a digest of the selected document, which is comparable by the originator of the request with a digest stored together with the document.

11. Method according to claim 6, wherein a digest is created by the trust center upon request of the originator and is then submitted to the originator.

12. Method according to claim 1, wherein the second communication device is identical to the first communication device.

13. A computer readable medium including program segments for, when executed on a computer device, causing the computer device to implement the method of claim 1.

14. A computer readable medium including program segments for, when executed on a computer device, causing the computer device to implement the method of claim 6.

15. Method according to claim 2, wherein the key is a private key of an asymmetric crypto system comprising pairs of public and private keys.

16. Method according to claim 2, wherein the second communication device is capable of communicating with the trust center according to an authentication protocol, whereby the authentication of the second communication device and a registered user of the second communication device are checked.

17. Method according to claim 2, wherein the second communication device is a cellular mobile phone equipped with software supporting the method.

18. Method according to claim 7, wherein the information submitted to the originator is the decrypted signature.

19. Method according to claim 18, wherein the decrypted signature is a digest of the selected document, which is comparable by the originator of the request with a digest stored together with the document.

20. Method according to claim 8, wherein the information submitted to the originator is the decrypted signature.

21. Method according to claim 20, wherein the decrypted signature is a digest of the selected document, which is comparable by the originator of the request with a digest stored together with the document.
